(19) United States
(12) Patent Application Publication
(10) Pub. No.: US 2004/0027999 A1
(43) Pub. Date: Feb. 12, 2004

(54) Broadcast message segmentation for wireless communication systems

(76) Inventors: Lorenzo Casaccia, San Diego, CA (US); Ragulan Sinnarajah, San Diego, CA (US)

Correspondence Address: Qualcomm Incorporated, Patents Department, 5775 Morehouse Drive, San Diego, CA, 92121-1714, US

(21) Appl. No.: 10/215,967

(22) Filed: Aug. 8, 2002

(51) Int. Cl. H04J 3/26; H04B 7/216

(52) U.S. Cl. 370/312; 370/432; 370/335; 370/342

(57) ABSTRACT

Techniques for transmitting and receiving segmented broadcast messages to improve performance. At a transmitter, a broadcast message to be transmitted over a wireless channel is partitioned into a number of segments and a header is formed for each segment. Each segment header may include (1) a sequence number, (2) a first segment indicator, and/or (3) a last segment indicator. A segmented broadcast message is generated with the segments and their headers, and is transmitted multiple times to improve reliability. At a receiver, one or more message repetitions are received for the segmented broadcast message. Each received message repetition is processed to recover good segments, if any, for the broadcast message. The good segments from the received message repetition(s) are then combined to recover the broadcast message. The processing may terminate whenever all segments of the broadcast message have been recovered.

### BACKGROUND

1. Field

The present invention relates generally to communication, and more specifically to techniques for transmitting and receiving segmented broadcast messages in wireless (e.g., CDMA) communication systems.

2. Background

Wireless communication systems are widely deployed to provide various types of communication such as voice, packet data, and so on. These systems may be multiple-access systems capable of supporting communication with multiple users and may be based on code division multiple access (CDMA), time division multiple access (TDMA), frequency division multiple access (FDMA), and so on.

In a wireless multiple-access system, various types of messages may be transmitted from the base stations to the user terminals in the system. These messages include user-specific (or dedicated) messages directed to specific terminals and broadcast (or common) messages intended to be received by multiple terminals. Each message type has certain characteristics and may be associated with certain requirements.

For example, broadcast messages typically need to be transmitted such that they can be reliably received by all of the intended terminals, which may be located throughout a base station's coverage area. However, whereas a retransmission scheme may be employed for dedicated messages to ensure a certain level of reliability, retransmission is not practical for broadcast messages. This is because (1) more reverse link resources would be needed to send feedbacks (e.g., negative acknowledgments) from multiple terminals and (2) the implementation of a retransmission scheme for multiple terminals would be much more complex for both the base station and the terminals.

Various techniques have been used to improve the reliability of broadcast message transmission. These conventional techniques include (1) transmitting broadcast messages at a low rate and with sufficient power so that even the most disadvantaged terminals would likely receive the messages correctly, (2) keeping the length of the broadcast messages (in unit of transmission frames) sufficiently short so that the likelihood of receiving any errors in a given message is reduced, and (3) transmitting each broadcast message multiple times (e.g., twice) to improve the likelihood of correctly receiving at least one transmission of the message. The desired level of performance can typically be achieved by manipulating any one or a combination of the factors described above.

For some wireless communication systems, longer broadcast messages may need to be sent over the air. It is well known that the likelihood of receiving an error in any portion of a transmitted message increases with longer message length. Thus, even with multiple transmissions of a long broadcast message, none of these transmissions may be received without any errors. In this case, it may not be possible to recover the broadcast message even with the multiple transmissions.

There is therefore a need in the art for techniques to transmit and receive broadcast messages in such a manner to improve the likelihood of their correct reception at the receivers.

### SUMMARY

Techniques are provided herein for transmitting and receiving segmented broadcast messages to achieve better performance (e.g., a lower message error rate). These techniques may be used in various wireless communication systems (e.g., CDMA and GSM systems).

In an embodiment, a method is provided for processing broadcast messages for transmission in a wireless (e.g., CDMA) communication system. In accordance with the method, a broadcast message is initially received for transmission over a wireless channel. The broadcast message is partitioned into a number of segments, and a header is formed for each segment. The header for each segment may include (1) a sequence number for the segment, (2) an indicator for whether or not the segment is the first segment of the broadcast message, (3) an indicator for whether or not the segment is the last segment of the broadcast message, or (4) any combination of the above. A segmented broadcast message is then generated with the segments and their headers. The segmented broadcast message is further processed and transmitted multiple times over the wireless channel to improve reliability. For a CDMA system, the segmentation may be performed at the Link Access Control (LAC) sublayer in Layer 2.

In another embodiment, a method is provided for recovering broadcast messages received via the wireless channel. In accordance with this method, one or more message repetitions are received for a segmented broadcast message. Each received message repetition is processed to recover good segments, if any, for the broadcast message. Each good segment may be identified based on the segment's header. The good segments from the one or more message repetitions are then combined to recover the broadcast message. The processing may terminate whenever all segments of the broadcast message have been recovered. If at least one segment has not been recovered from all of the received message repetition(s) processed thus far, then a subsequent message repetition (if available) for the broadcast message is processed.

Various aspects and embodiments of the invention are described in further detail below. The invention further provides methods, program codes, digital signal processors, receiver units, transmitter units, terminals, base stations, systems, and other apparatuses and elements that implement various aspects, embodiments, and features of the invention, as described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 shows a wireless communication system that can transmit segmented broadcast messages;

FIGS. 2A and 2B illustrate an example broadcast message transmission without and with segmentation, respectively;

FIGS. 3A and 3B show the processing for broadcast message segmentation/transmission and broadcast message reception/assembly, respectively;

FIG. 4 shows a layer structure defined by cdma2000 Release C;

FIG. 5 illustrates the processing for broadcast message segmentation within the LAC sublayer;

FIGS. 6A through 6C show three embodiments of a segment header;

FIG. 7 shows a generic process for performing broadcast message segmentation at a transmitter;

FIGS. 8A and 8B show a generic process and a specific process, respectively, for receiving a segmented broadcast message at a receiver; and

FIG. 9 is a block diagram of a base station and a terminal.

### DETAILED DESCRIPTION

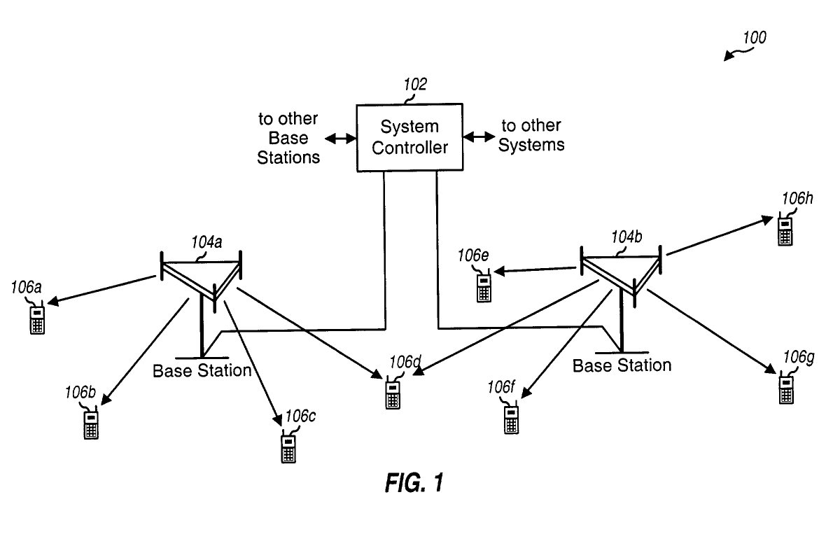

FIG. 1 is a diagram of a wireless communication system 100 that can transmit segmented broadcast messages. System 100 includes a number of base stations 104 that communicate with a number of terminals 106. The base stations are fixed stations used for communicating with the terminals. A base station may also be referred to as a base transceiver system (BTS), an access point, a Node B, or some other terminology.

Various terminals 106 may be dispersed throughout the system. A terminal may also be referred to as a mobile station, a remote station, an access terminal, user equipment (UE), or some other terminology. Each terminal 106 may communicate with one or more base stations 104 on the forward link (downlink) and/or reverse link (uplink) at any given moment, depending on whether or not the terminal is active, whether or not soft handoff is supported, and whether or not the terminal is in soft handoff. Alternatively or additionally, each terminal may receive page and/or broadcast messages via overhead channels from the base stations, even if it is not in active communication with the base station. In the example shown in FIG. 1, terminals 106a through 106d receive broadcast messages from base station 104a, and terminals 106d through 106h receive broadcast messages from base station 104b. Terminal 106d is located in an overlapping coverage area and receives broadcast messages from base stations 104a and 104b.

A system controller 102 couples to base stations 104 and may further couple to other systems such as a public switched telephone network (PSTN), a packet data node (PDN), and so on. System controller 102 provides coordination and control for the base stations coupled to it. Via the base stations, system controller 102 controls the routing of calls (1) among the terminals, and (2) between the terminals and other users coupled to the PSTN (e.g., conventional telephones) and PDN. System controller 102 may also be referred to as a base station controller (BSC), a mobile switching center (MSC), a radio network controller (RNC), or some other terminology.

The techniques described herein for transmitting and receiving segmented broadcast messages may be implemented in various wireless communication systems. Thus, system 100 may be a code division multiple access (CDMA) system, a time division multiple access (TDMA) system, a frequency division multiple access (FDMA) system, or some other type of system. A CDMA system may be designed to implement one or more standards such as cdma2000, IS-856, W-CDMA, IS-95, and so on. A TDMA system may be designed to implement one or more standards such as Global System for Mobile Communications (GSM). These standards are well known in the art and incorporated herein by reference.

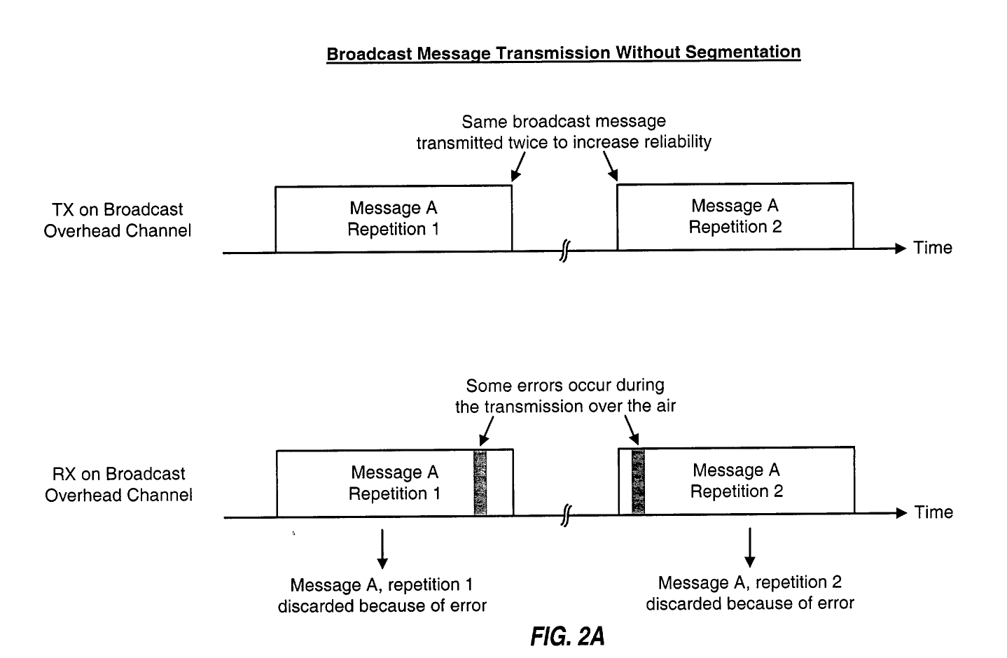

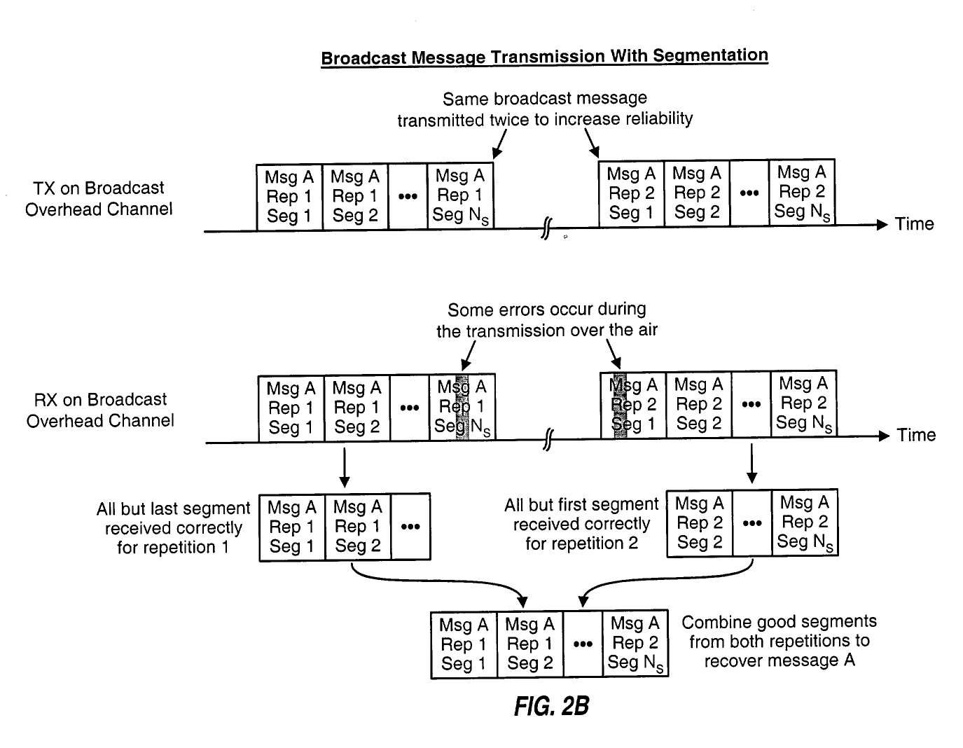

FIG. 2A is a diagram illustrating an example broadcast message transmission without segmentation. The top of FIG. 2A shows a timeline for the transmitter and the bottom of FIG. 2A shows the timeline for the receiver. In this example, the same broadcast message is transmitted twice by the transmitter to increase reliability. The second transmission of the broadcast message (labeled as repetition 2) is sent some amount of time after the first message transmission. As used herein, a message repetition is one transmission instance of a message. A message repetition may be for the entire message or only a portion of the message.

At the receiver, the first transmission or repetition of the broadcast message is received and processed to attempt to recover the message. In this example, an error occurs in a portion of the first message transmission, and the received message for the first repetition is discarded because of the error. Since the broadcast message has not been recovered (i.e., not received correctly), the second transmission of the broadcast message is also received and processed to again attempt to recover the message. However, in this example, an error also occurs in a portion of the second message transmission, and the received message for the second repetition is also discarded because of this error. In this example, because some errors occur during portions of the first and second message transmissions, the broadcast message cannot be recovered by the receiver. For some receiver designs, the received symbols for the first and second message transmissions may be combined and then processed to attempt to recover the broadcast message. However, the “soft-combining” generally takes place at the physical layer and further requires processing power at the physical layer that is typically not used for broadcast messages.

FIG. 2B is a diagram illustrating an example broadcast message transmission with segmentation. Similar to FIG. 2A, the same broadcast message is transmitted twice by the transmitter to increase reliability. However, the broadcast message is partitioned into N_{S} segments prior to transmission. Each segment is formatted such that it can be identified by the receiver. (However, the receiver does not need to distinguish between segment y of repetition 1 and segment y of repetition 2.)

At the receiver, the first transmission or repetition of the broadcast message is received and processed to attempt to recover the message. Similar to FIG. 2A, an error occurs in a portion of the first message transmission. However, since the broadcast message has been partitioned into segments, only the bad segment(s) where errors have occurred are discarded. The good segments are temporarily stored in a buffer. The determination of whether a segment is good or bad is described below. The missing segment(s) for the broadcast message may also be identified.

Since the broadcast message has not been recovered, the second transmission of the broadcast message is also received and processed. In this example, an error also occurs in a portion of the second message transmission. Again, since the broadcast message has been partitioned into segments, the bad segment(s) where errors have occurred can be discarded and the good segments can be saved. If the missing segments from the earlier transmission have been identified, then only these segments would need to be saved.

After all of the required segments for the broadcast message have been recovered, the good segments from the first message transmission are combined with the good segments from the second message transmission to recover the broadcast message. As shown by this example, by partitioning the broadcast message into segments and transmitting the segmented broadcast message, the receiver can recover the broadcast message even if errors occurred in both message transmissions.

In a wireless communication system, broadcast messages are typically generated at a higher layer and provided to lower layers, which then process and transmit each broadcast message in one or more frames. As used herein, a frame is a unit of transmission, and each frame typically covers a particular time period (e.g., 5, 10, or 20 msec). The probability of receiving a given frame incorrectly (i.e., erased) may be given by a particular frame error rate (FER). If N_{F} frames are used to transmit a given broadcast message, then the probability of receiving this broadcast message incorrectly may be expressed as:

MER₁=1−(1−FER)^{N}^{_{F}}, Eq (1)

where MER₁ is the message error rate based on a single transmission of the broadcast message (i.e., a single message repetition).

For simplicity, equation (1) and the following derivations assume statistical independence of events (e.g., the probability of an error in any given frame is equal to the probability of an error in any other frame). Equation (1) also assumes that all N_{F} frames need to be received correctly in order to recover the broadcast message. As shown in equation (1), for a given value of FER, the MER increases with longer message length.

The lengths of broadcast messages and segments are often given in unit of transmission frames. The capacity of each transmission frame (in bits) may be different from frame to frame, depending on the data rate used for the frame. Thus, two segments A and B may have the same length in frames but different length in bits. For example, segments A and B may both be one frame in length, but the frame used for segment A may have a capacity of X bits whereas the frame used for segment B may have a capacity of Y bits. Segments A and B would be considered to have the same length, which is one frame.

For a broadcast message with longer length, more frames are required to transmit the message. If all frames are required to be received correctly in order to recover the message, which may be the case for a broadcast message transmission without segmentation, then the message error rate would increase for longer broadcast message due to a greater number of frames required to be transmitted and received correctly for the message.

The message error rate may be reduced by transmitting the same broadcast message multiple times. With the assumption of statistical independence of events, the message error rate MER_{N}_{_{T}} for N_{T} transmissions of the same broadcast message may be expressed as:

MER_{N}_{_{T}}=(MER₁)^{N}^{_{T}}. Eq (2)

Correspondingly, the probability of recovering a given broadcast message based on N_{T} transmissions of the message can be given as (1−MER_{N}_{_{T}}).

It can be shown that improved performance (i.e., a lower message error rate) may be obtained by transmitting segmented broadcast messages. A broadcast message may be partitioned into N_{S} segments, and each segment may be transmitted using N_{SF} frames. The segment error rate SER₁ for a single transmission of a given segment may be expressed as:

SER₁=1−(1−FER)^{N}^{_{SF}}. Eq (3)

The segment error rate SER_{N}_{_{T}} for N_{T} transmissions of the same segment may be expressed as:

SER_{N}_{_{T}}=(SER₁)^{N}^{_{T}}. Eq (4)

Since all N_{S} segments are needed to recover the broadcast message, the message error rate MER_{N}_{_{T}} based on N_{T} transmissions of the same segmented broadcast message may be expressed as:

MER_{N}_{_{T}}=1−(1−SER_{N}_{_{T}})^{N}^{_{S}}. Eq (5)

The improvement in the message error rate with segmented broadcast message transmission may be illustrated by a specific example. In this example, a broadcast message is partitioned into four segments (i.e., N_{S}=4), and each segment is transmitted using one frame (i.e., N_{SF}=1). Without segmentation, four frames would be required to transmit this broadcast message (i.e., N_{F}=4). In this example, the broadcast message is transmitted twice (i.e., N_{T}=2), and the frame error rate is 1 percent (i.e., FER=1%).

Without segmentation, the MER with a single message transmission can be computed as MER₁=3.94%, and the MER with two message transmissions can be computed as MER₂=0.155%.

With segmentation, the SER with a single segment transmission can be computed as SER₁=1%, the SER with two segment transmissions can be computed as SER₂=0.01%, and the MER with two message transmissions can be computed as MER₂=0.04%. For this specific example, the MER improves from 0.155% to 0.04% with the use of segmentation.

The amount of improvement in the MER increases with longer message length. For example, if the broadcast message length doubles and the other parameters are the same for the above example (i.e., N_{S}=8, N_{SF}=1, N_{F}=8, N_{T}=2, and FER=1%), then the MER for two message transmissions without segmentation can be computed as MER₂=0.60%, while the MER for two message transmissions with segmentation can be computed as MER₂=0.08%.

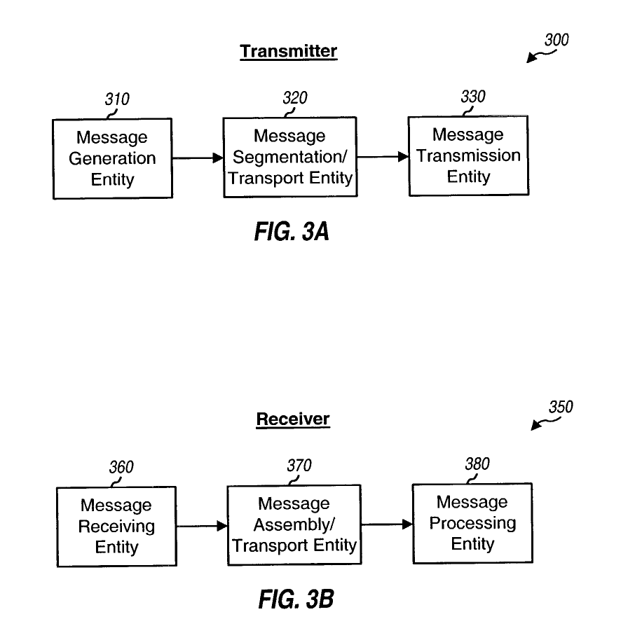

FIG. 3A is a simplified block diagram of the processing for broadcast message segmentation and transmission by a transmitter 300 (e.g., a base station). A message generation entity 310 (which may be an application or service at a higher layer) generates broadcast messages for transmission to the receivers (e.g., the terminals). A message segmentation/transport entity 320 receives the broadcast messages, performs transport functions for each message, and further performs segmentation on the message. The transport functions may include, for example, (1) generating and appending the appropriate header and possibly trailer for each message, (2) adding forward error correcting (FEC) fields for error control, and so on. A message transmission entity 330 then receives and processes the segmented broadcast messages for transmission over a wireless communication channel.

FIG. 3B is a simplified block diagram of the processing for broadcast message reception and assembly at a receiver 350 (e.g., a terminal). A message receiving entity 360 receives and processes the over-the-air transmissions of the broadcast messages. A message assembly/transport entity 370 receives the data from entity 360, performs transport functions for each received message, determines whether each segment of the message has been received correctly or in error, and performs assembly of good segments obtained from one or more message transmissions to recover the broadcast message. A message processing entity 380 (e.g., at a higher layer) then receives and processes each recovered broadcast message.

The broadcast message segmentation described herein may be used in various wireless communication systems and implemented in various manners. For clarity, the broadcast message segmentation is specifically described below for a cdma2000 system.

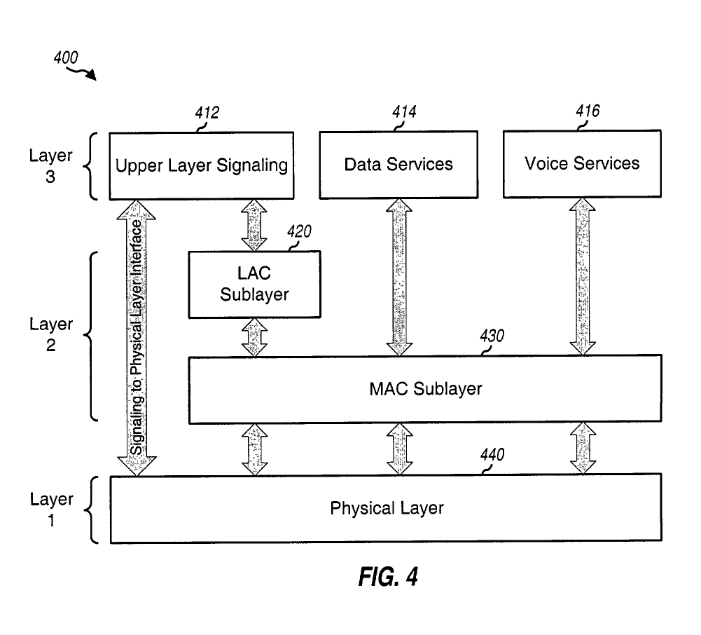

FIG. 4 is a diagram of a layer structure 400 defined by cdma2000 Release C. Layer structure 400 includes (1) applications and upper layer protocols that approximately correspond to Layer 3 of the ISO/OSI reference model, (2) protocols and services that correspond to Layer 2 (the link layer), and (3) protocols and services that correspond to Layer 1 (the physical layer).

Layer 3 includes various applications and upper layer protocols, such as signaling services 412, packet data services 414, voice services 416, circuit data applications, and so on. Signaling services 412 in Layer 3 originate and terminate signaling messages (e.g., broadcast messages) according to the semantics and timing of the communication protocol between the base station and the terminal. Layer 3 utilizes the services provided by Layer 2.

Layer 2 supports the delivery of signaling messages generated by Layer 3. Layer 2 includes two sublayers: a Link Access Control (LAC) sublayer 420 and a Medium Access Control (MAC) sublayer 430. The LAC sublayer implements a data link protocol that provides for the correct transport and delivery of signaling messages generated by Layer 3. The LAC sublayer utilizes the services provided by the MAC sublayer and Layer 1. The MAC sublayer implements the medium access protocol and is responsible for transporting LAC protocol data units using the services provided by Layer 1.

Layer 1 (physical layer 440) provides for the transmission and reception of radio signals between the base station and the terminal.

The LAC sublayer is described in detail in a document TIA/EIA/IS-2000.4C, entitled “Signaling Link Access Control (LAC) Standard for cdma2000 Spread Spectrum Systems,” Release C. The MAC sublayer is described in detail in TIA/EIA/IS-2000.3-C, entitled “Medium Access Control (MAC) Standard for cdma2000 Spread Spectrum Systems,” Release C. These documents are incorporated herein by reference.

For the cdma2000 layer structure shown in FIG. 4, broadcast messages are provided by signaling services 412 in Layer 3 to the LAC sublayer. The segmentation of broadcast messages can thus be conveniently performed within the LAC sublayer. Alternatively, the broadcast message segmentation may also be performed in the MAC sublayer or the physical layer. The segmentation of broadcast messages within the LAC sublayer is described in further detail below.

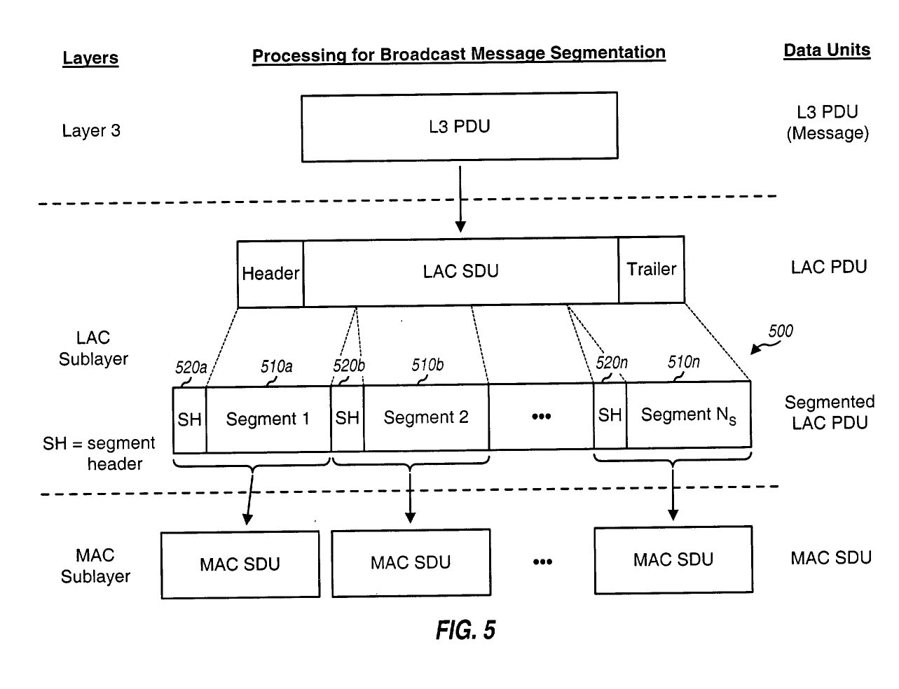

FIG. 5 is a diagram illustrating a specific embodiment of the processing for broadcast message segmentation within the LAC sublayer. Layer 3 generates broadcast messages for transmission from the base station to the terminals. Each message represents a signaling data unit and is provided by Layer 3 as a Layer 3 protocol data unit (L3 PDU). The LAC sublayer receives the L3 PDUs, with each L3 PDU being referred to a LAC service data unit (SDU). The LAC sublayer generates a header and a trailer for each LAC SDU. The header may include (1) a protocol field used to identify the LAC protocol version, (2) a message ID field used to identify the LAC SDU's message action or use (e.g., for authentication, configuration of parameters, and so on), (3) an encryption indicator field for whether or not the LAC SDU is encrypted, and (4) a sequence number for the LAC SDU. The trailer may include padding bits. The combination of the LAC SDU and its header and trailer is referred to as a LAC PDU. The LAC processing up to this point is as defined by cdma2000.

To perform broadcast message segmentation, the LAC PDU is first partitioned into N_{S} segments 510a through 510n, where N_{S} may be any integer two or greater and may even be different from one LAC PDU to another. The LAC sublayer then generates and appends a segment header (SH) 520 to each segment. A segmented LAC PDU 500 is generated for each LAC PDU using the N_{S} segments and their headers.

Each segment header includes pertinent information for the associated segment. The segment headers are defined to include sufficient information to allow the terminals to identify each segment. This is needed to facilitate the assembly/combining of segments from multiple broadcast message transmissions. Several designs for the segment headers are described in further detail below.

The N_{S} segments for a given LAC PDU may have equal length (where the length can be given in units of transmission frames), which can simplify their processing. Alternatively, these N_{S} segments may have different lengths. The segment length may also be selected to coincide with length of the data unit at the next lower level. In a specific embodiment and as shown in FIG. 5, each segment is defined to correspond to a single MAC SDU, which is the data unit provided by the LAC sublayer to the MAC sublayer. In other embodiments, each segment may be defined to correspond to multiple MAC SDUs or to a fraction of a MAC SDU.

The MAC sublayer receives and processes MAC SDUs from the LAC sublayer in the normal manner. The MAC sublayer does not need to be aware of the message segmentation performed by the LAC sublayer. The MAC sublayer provides one MAC frame to the physical layer for each MAC SDU. The physical layer further processes each MAC frame to generate a corresponding transmission frame. The processing by the physical layer for each MAC frame may include (1) appending a header with control bits, and (2) generating and appending a CRC value for the MAC frame. The CRC value may be used by receivers to determine whether the frame was received correctly or in error. Each transmission frame is then transmitted over the air.

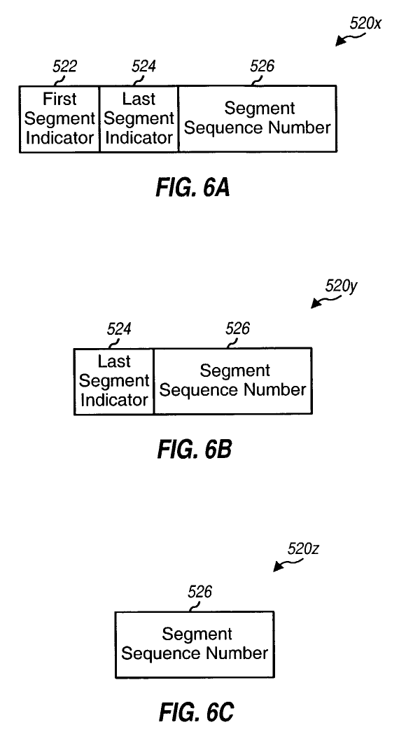

FIGS. 6A through 6C are diagrams showing three embodiments of the segment header. In the embodiment shown in FIG. 6A, a segment header 520x includes three fields: a first segment indicator field 522, a last segment indicator field 524, and a segment sequence number field 526. The first segment indicator field may be set to one (“1”) to indicate that the associated segment is the first segment of the broadcast message and to zero (“0”) otherwise. The last segment indicator field may be set to one (“1”) to indicate that the associated segment is the last segment of the broadcast message and to zero (“0”) otherwise. The segment sequence number field includes a value (i.e., a sequence number) used to uniquely identify the associated segment. The sequence number starts at a particular initial value for the first segment of the broadcast message and thereafter increments by one for each subsequent segment of the same broadcast message.

For segment header 520x, the terminals can determine the start and end of each broadcast message based on the first and last segment indicators. In this case, the sequence number can start at any value for each broadcast message. Each segment of the broadcast message can then be identified by the sequence number for that segment and the sequence number for the first segment. The terminals can use these indicators along with the sequence numbers to identify the segments for each message transmission and to combine segments from multiple message transmissions.

In the embodiment shown in FIG. 6B, a segment header 520y includes two fields: last segment indicator field 524 and segment sequence number field 526. These fields are described above. Since segment header 520y does not include the first segment indicator, the sequence number may be set to a known value (e.g., 0) for the first segment of each broadcast message. The terminals would then be able to determine the start of each broadcast message based on the sequence number.

In the embodiment shown in FIG. 6C, a segment header 520z includes one field: segment sequence number field 526. Again, the sequence number may be set to a known value (e.g., 0) for the first segment of each broadcast message. This would then allow the terminals to determine the start of each broadcast message. Some other mechanisms may be used to determine whether or not the entire message has been received for a given message transmission.

Other designs may also be used for the segment header, and this is within the scope of the invention. For example, the segment header may include only the first and last segment indicator fields. In this case, other information may be relied upon to identify each segment of a given broadcast message. This header design may be used, for example, if the segments of each broadcast message are of equal lengths and are transmitted sequentially. In general, simpler segment headers containing less information may be used if more structured transmission schemes are used for the broadcast messages.

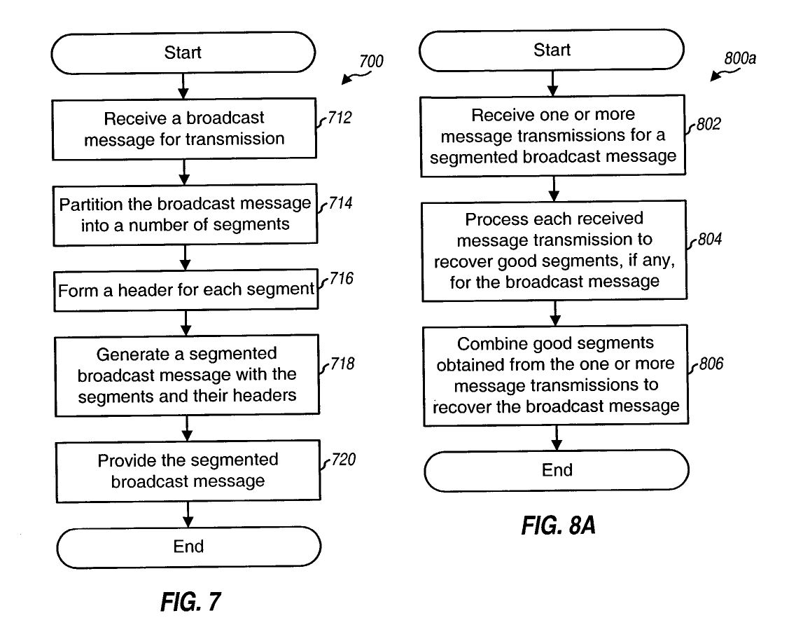

FIG. 7 is a flow diagram of a process 700 for performing broadcast message segmentation at a transmitter (e.g., a base station). Process 700 may be performed, for example, within the LAC sublayer in a CDMA system.

Initially, a broadcast message is received (e.g., from Layer 3) for transmission over a wireless communication channel (step 712). The broadcast message is then partitioned into a number of segments (step 714). The segments may have the same length or different lengths. The number of segments to be formed for the broadcast message may be determined by the length of the broadcast message and/or some other factors. A header is then formed for each segment (step 716). Each header may include various types of information, such as those shown in FIG. 6A. A segmented broadcast message is then generated with the segments and their header (step 718) (e.g., as shown in FIG. 5). The segmented broadcast message may then be provided (e.g., to the MAC sublayer) for further processing and subsequent transmission.

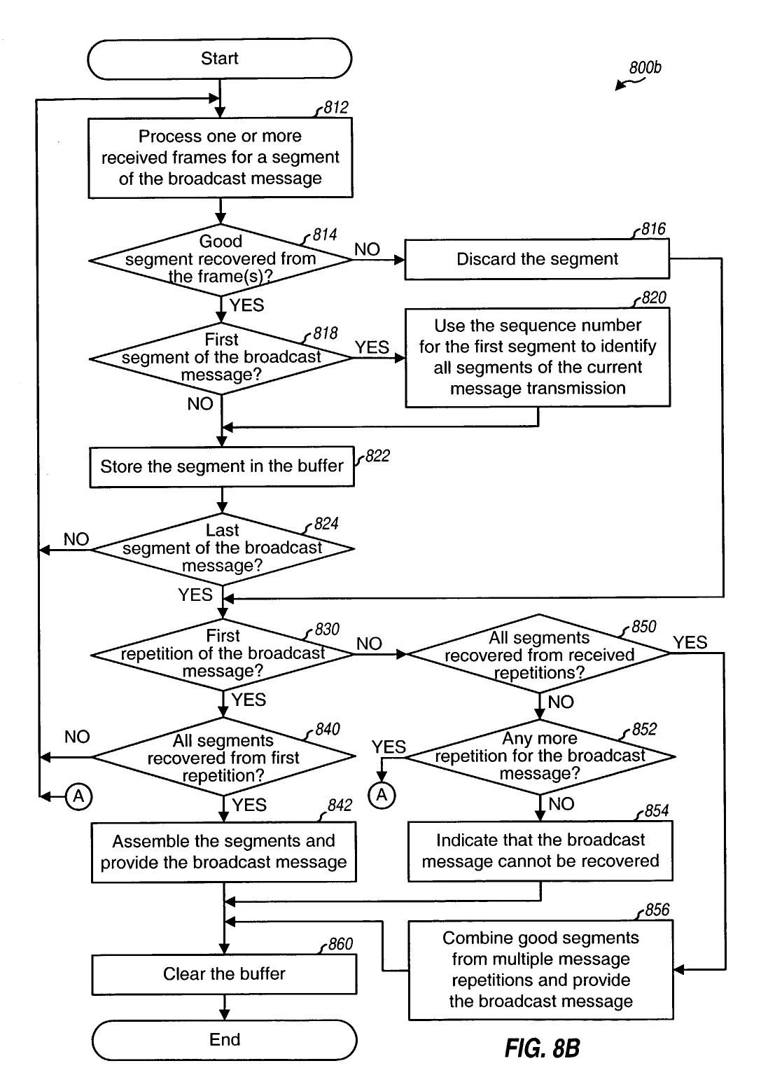

FIG. 8A is a flow diagram of a generic process 800a for receiving a broadcast message with segmentation at a receiver (e.g., a terminal). Initially, one or more message transmissions for a segmented broadcast message are received (step 802). Each received message transmission is processed to recover good segments, if any, for the broadcast message (step 804). The processing of the received message transmission(s) can terminate early once all of the required segments for the broadcast message have been recovered. The good segments from the one or more message transmissions are then combined to recover the broadcast message (step 806).

FIG. 8B is a flow diagram of a specific process 800b for receiving a broadcast message with segmentation at a receiver. Process 800b represents a specific implementation for the receiver processing for segmented broadcast messages.

Initially, one or more received frames for a segment of the broadcast message are processed (step 812). A determination is then made whether the segment is good (i.e., recovered) or bad (i.e., erased) (step 814). Each segment may be transmitted in one frame. In this case, the CRC generated by the physical layer for each frame may be used to determine whether or not a given segment is good or bad. If the segment is bad, then it is discarded (step 816), and the process proceeds to step 830.

Otherwise, if the segment is determined to be good in step 814, then a determination is made whether or not it is the first segment of the broadcast message (step 818). This determination can be made based on the first segment indicator or the sequence number in the segment header. If the answer is no, then the process proceeds to step 822. Otherwise, the sequence number for this first segment is used to identify all segments of the current message transmission (step 820). In particular, for the header implementation in which the sequence number is not reset to a known value (e.g., 0) for the first segment of each message transmission, the sequence numbers for all segments in the current message transmission may be determined relative to the sequence number of the first segment. The process then proceeds to step 822.

In step 822, the good segment just recovered from the received frame(s) is stored in the buffer. Step 822 may be skipped if the same segment has already been recovered from an earlier message transmission and saved in the buffer. A determination is then made whether or not this segment is the last segment of the broadcast message (step 824). For the embodiment shown in FIG. 8B, the segments are assembled or combined only after the last segment has been received (or a bad segment was received, and it is not known whether or not it was the last segment). Thus, if the current segment is not the last segment, then the process returns to step 812 to process the received frame(s) for the next segment.

If the last segment has been received, as determined in step 824, then a determination is made whether or not the current message transmission is the first message repetition (step 830). If the answer is yes, then a determination is made whether or not all segments of the broadcast message have been recovered from the first message repetition (step 840). If all segments have not been recovered, then the process returns to step 812 to process the frames for the second message transmission. Otherwise, if all segments have been recovered, then the segments are assembled and the broadcast message is provided (e.g., to Layer 3) (step 842). The process then proceeds to step 860.

If the current message transmission is not the first repetition of the broadcast message (as determined in step 830), then a determination is made whether or not all segments of the broadcast message have been recovered from all repetitions received thus far (step 850). This determination may be made based on the segment sequence number in the header of each good segment. If the answer is no, then a determination is made whether or not there will be another transmission for the broadcast message (step 852). If all repetitions for the broadcast message have been received, then an indication may be provided that the broadcast message cannot be recovered (step 854), and the process would proceed to step 860. Otherwise, if there is another transmission forthcoming for the broadcast message, then the process returns to step 812 to process the frames for the next message transmission.

Back in step 850, if it is determined that all segments have been recovered, then the good segments from the multiple repetitions are combined, and the broadcast message is provided (step 856). The process then proceeds to step 860.

In step 860, regardless of whether or not the current broadcast message has been recovered, the buffer is cleared to get ready for the next broadcast message. The process then terminates.

Techniques for segmenting messages are also described in detail in U.S. patent application Ser. No. 09/932,121, entitled “Method and Apparatus for Message Segmentation in a Wireless Communication System,” filed Aug. 16, 2001, assigned to the assignee of the present application and incorporated herein by reference.

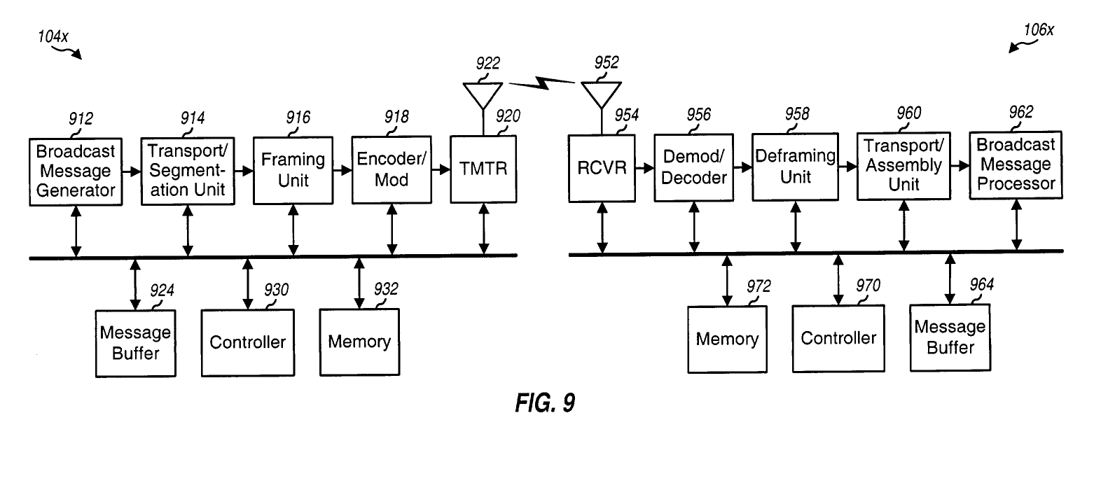

FIG. 9 is a block diagram of an embodiment of a base station 104x and a terminal 106x, which are capable of transmitting and receiving segmented broadcast messages. Terminal 106x may be a cellular phone, a handset, a modem, or some other device or design.

At base station 104x, a broadcast message generator 912 generates broadcast messages to be sent to the terminals. For each broadcast message, a transport/segmentation unit 914 performs transport functions as well as segmentation of the broadcast message to provide a corresponding segmented broadcast message. A message buffer 924 may be used to store broadcast messages to be processed for transmission and segmented broadcast messages to be transmitted multiple times.

For each segmented broadcast message to be transmitted, a framing unit 916 further processes the message to generate a set of frames. An encoder/modulator 918 then codes, interleaves, and modulates each frame to provide modulated data. A transmitter unit (TMTR) 920 further processes (e.g., amplifies, filters, and frequency upconverts) the modulated data to generate a modulated signal for transmission from an antenna 922. The modulated signal may include multiple transmissions (or repetitions) of each segmented broadcast message.

At terminal 106x, the transmitted signal is received by an antenna 952 and provided to a receiver unit (RCVR) 954. Receiver unit 954 conditions (e.g., filters, amplifies, and frequency downconverts) the received signal and digitizes the conditioned signal to provide samples. A demodulator/decoder 956 then demodulates, deinterleaves, and decodes the samples to provide decoded data. A deframing unit 956 concatenates the data from all of the frames received for each message repetition to provide a received message repetition. An transport/assembly unit 960 identifies the segments in each received message repetition, determines whether or not each segment is good or bad, and performs assembly/combining of good segments from one or more received message repetitions to provide a recovered broadcast message. A broadcast message processor 962 then processes each recovered broadcast message. A message buffer 964 may be used to store good segments from each received message repetition for subsequently assembly/combining.

The processing by demodulator/decoder 956, deframing unit 958, and transport/assembly unit 960 is complementary to that performed by encoder/modulator 918, framing unit 916, and transport/segmentation unit 914, respectively. Units 912 and 962 may perform the processing for Layer 3, units 914 and 960 may perform the processing for the LAC sublayer, units 916 and 958 may perform the processing for the MAC sublayer, and units 918 and 956 may perform the processing for the physical layer.

Controllers 930 and 970 may perform various functions for voice, data, and messaging communication and may also direct the operation of various processing units within base station 104x and terminal 106x, respectively. Memory units 932 and 972 may store data and program codes used by various processing units within base station 104x and terminal 106x, respectively. The interface between various processing units within each of base station 104x and terminal 106x may be provided by a bus.

The techniques described herein for transmitting and receiving segmented broadcast messages may be implemented by various means. For example, these techniques may be implemented in hardware, software, or a combination thereof. For a hardware implementation, the units used to implement any one or a combination of the techniques (e.g., units 912, 914, and 916 for the transmitter, and units 958, 960, and 962 for the receiver) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For a software implementation, the techniques for transmitting and receiving segmented broadcast messages may be implemented with modules (e.g., procedures, functions, and so on) that perform the functions described herein. The software codes may be stored in a memory unit (e.g., memory units 932 and 972 in FIG. 9) and executed by a processor (e.g., controllers 930 and 970). The memory unit may be implemented within the processor or external to the processor, in which case it can be communicatively coupled to the processor via various means as is known in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. In a wireless communication system, a method for processing broadcast messages for transmission over a wireless channel, comprising:
receiving a broadcast message for transmission;
partitioning the broadcast message into a plurality of segments;
forming a header for each segment; and
generating a segmented broadcast message with the plurality of segments and the associated headers.

2. The method of claim 1, wherein each header includes a sequence number for the associated segment.

3. The method of claim 2, wherein each header further includes an indicator for whether or not the associated segment is a first segment of the broadcast message.

4. The method of claim 2, wherein each header further includes an indicator for whether or not the associated segment is a last segment of the broadcast message.

5. The method of claim 1, wherein the plurality of segments have equal length.

6. The method of claim 1, further comprising:
transmitting the segmented broadcast message a plurality of times over the wireless channel.

7. The method of claim 1, wherein the wireless communication system is a CDMA system.

8. The method of claim 7, wherein the partitioning, forming, and generating are performed within a Link Access Control (LAC) sublayer.

9. The method of claim 1, wherein the partitioning, forming, and generating are performed at a base station in the wireless communication system.

10. In a wireless communication system, a method for recovering broadcast messages received via a wireless channel, comprising:
receiving one or more message repetitions for a broadcast message that has been partitioned into a plurality of segments;
processing each received message repetition to recover good segments, if any, for the broadcast message; and
combining the good segments from the one or more message repetitions to recover the broadcast message.

11. The method of claim 10, wherein each good segment is identified based on an associated header.

12. The method of claim 11, wherein the header for each segment includes a sequence number for the segment.

13. The method of claim 10, further comprising:
identifying a last segment for a current message repetition being processed; and
determining whether or not the plurality of segments of the broadcast message have all been recovered from all message repetitions processed for the broadcast message.

14. The method of claim 10, further comprising:
terminating the processing if the plurality of segments of the broadcast message has all been recovered from a first message repetition.

15. The method of claim 10, further comprising:
processing a subsequent message repetition if at least one segment has not been recovered from all message repetitions processed for the broadcast message.

16. The method of claim 10, wherein the wireless communication system is a CDMA system.

17. A memory communicatively coupled to a digital signal processing device (DSPD) capable of interpreting digital information to:
receive a broadcast message for transmission;
partition the broadcast message into a plurality of segments;
form a header for each segment; and
generate a segmented broadcast message with the plurality of segments and the associated headers.

18. An apparatus in a wireless communication system, comprising:
means for receiving a broadcast message for transmission;
means for partitioning the broadcast message into a plurality of segments;
means for forming a header for each segment; and
means for generating a segmented broadcast message with the plurality of segments and the associated headers.

19. A transmitter unit in a wireless communication system, comprising:
a broadcast message generator operative to generate broadcast messages for transmission; and
a segmentation unit operative to partition each broadcast message into a plurality of segments, form a header for each segment, and generate a segmented broadcast message for the broadcast message with the plurality of segments and the associated headers.

20. The transmitter unit of claim 19, further comprising:
a framing unit operative to generate one or more frames for each segmented broadcast message.

21. The transmitter unit of claim 19, wherein each segmented broadcast message is transmitted a plurality of times over a wireless channel.

22. A base station comprising the transmitter unit of claim 19.

23. An apparatus in a wireless communication system, comprising:
means for receiving one or more message repetitions for a broadcast message that has been partitioned into a plurality of segments;
means for processing each received message repetition to recover good segments, if any, for the broadcast message; and
means for combining the good segments from the one or more message repetitions to recover the broadcast message.

24. A receiver unit in a wireless communication system, comprising:
a deframing unit operative to process frames received via a wireless channel to provide one or more message repetitions for a broadcast message that has been partitioned into a plurality of segments; and
an assembly unit operative to process each received message repetition to recover good segments, if any, for the broadcast message, and to combine the good segments from the one or more message repetitions to recover the broadcast message.

25. The receiver unit of claim 24, further comprising:
a buffer operative to store good segments recovered from the one or more received message repetitions for subsequent combining.

26. The receiver unit of claim 24, wherein the deframing unit and assembly unit are operative to process a subsequent message repetition if at least one segment has not been recovered from all message repetitions processed for the broadcast message.

27. A terminal comprising the receiver unit of claim 24.
